(19) United States
(12) Patent Application Publication
(10) Pub. No.: US 2006/0062013 A1
(43) Pub. Date: Mar. 23, 2006

(54) Light guiding apparatus, illumination apparatus and image projection system

(75) Inventor: Shinichi Imade, Iruma-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/228,076

(22) Filed: Sep. 16, 2005

(30) Foreign Application Priority Data
Sep. 22, 2004 (JP) 2004-274869

(51) Int. Cl. F21V 7/04

(52) U.S. Cl. 362/551

(57) ABSTRACT

The invention is directed to a light guiding apparatus for guiding illumination light from a light source to an illuminated area. The light guiding apparatus comprises a plurality of light guiding rods, each including a first entrance end face, a first exit end face of an area smaller than that of the first entrance end face, and a first reflection surface for guiding the illumination light incident on the first entrance end face to the first exit end face while reflecting the illumination light at an inner surface thereof; and a tapered rod including a second entrance end face, a second exit end face of an area larger than that of the second entrance end face, and a second reflection surface for guiding the illumination light to the second exit end face while reflecting the illumination light incident on the second entrance end face at an inner surface thereof, wherein each of the first exit end faces of the light guiding rods is in contact with the second entrance end face and a total of the areas of the first exit end face is almost equal to an area of the second entrance end face. The invention also relates to an illumination apparatus using the light guiding apparatus and an image projection system incorporating the illumination apparatus.

### PRIORITY CLAIM

Priority is claimed on Japanese Patent Application No. 2004-274869, filed Sep. 22, 2004, the content of which is incorporated herein by reference.

### BACKGROUND OF THE INVENTION

1. Field of the Invention

The invention relates to a light guiding apparatus that is small and effectively reduces illumination unevenness of illumination light, an illumination apparatus using the light guiding apparatus, and an image projection system employing the illumination apparatus.

2. Description of Related Art

These days, during rapid advancement to higher brilliance of light emitting diodes (LEDs), an illumination apparatus using a high brilliance LED has been gradually used in place of what is called a lamp illumination apparatus employing a lamp light source such as a conventional halogen lamp and a xenon lamp.

Since the LEDs just mentioned above have by far longer life, faster response, and better color rendering compared with conventional lamp sources, attention has been paid as a light source for the next generation having important utility value. Recently, realization of not only red, green and blue LEDs but also white LEDs with higher brilliance has been remarkable and has come to a stage in which conventional white illumination can be replaced.

The illumination apparatus is generally considered to have an application in which a relatively wide area is uniformly illuminated, and an application in which a relatively small area is focused as a spot light. In order to obtain illumination light for a spotlight use by a LED light source, various proposals have been made in which a tapered rod is applied for making an outgoing light bean angle smaller. See, for example, Japanese Patent Unexamined Publication Hei 8-234109, Japanese Patent No. 3048353 and U.S. Pat. No. 5,902,033.

Since the LEDs used for an illumination apparatus is a surface light emission and diffusion light source, they cannot readily create parallel emission light by a concave reflection mirror as does a point light source. Using a tapered rod to solve this problem is a relatively easy and effective means that makes an angle for illumination light smaller. Light beam angle conversion effect for the tapered rod (NA conversion effect) is determined by a ratio of an exit area to an entrance area. The larger the ratio, the smaller the light beam angle can be made.

Japanese Patent Unexamined Publication Hei 8-234109 and Japanese Patent No. 3048353 describe an illumination apparatus using a tapered rod which has a shape satisfying an allowable light beam angle for outgoing light and an outgoing area. U.S. Pat. No. 5,902,033 discloses a light guiding apparatus used in a projector. The light guiding apparatus forms an optical system so that incoming light is narrowed down by a reverse tapered rod whose central cross-sectional area parallel to an entrance end face is smaller than an area of the entrance end face, and then outgoing light is held within an allowable light beam angle by a tapered rod where an area of an exit end face is larger than the central cross-sectional area.

The display device such as a LCD (Liquid Crystal Device) and a digital micro-mirror device (called “DMD” hereinbelow) widely used in an image projection display apparatus has a fairly small allowable light beam angle for illumination light that is effectively used. Therefore, illumination light from an illumination apparatus should have the characteristics that light beam angle conversion effect can be enhanced, and that a light beam angle is small.

The tapered rod described in the above prior art is extremely effective as an optical element which can make an optical system compact and convert into light beam with a small light beam angle light beam with a large light beam angle from a surface light emission and diffusion light source such as an LED. For example, in a case of a projector (an image projection apparatus), a tapered rod is used to make smaller a light beam angle for illumination light a display device can allow. Moreover, the illumination light should have small surface unevenness. When the effect is tried to be improved by the tapered rod, since reflection number of times of light beam at the inner surface of the tapered rod should be large, the tapered length must be long.

The present invention is related to a light guiding apparatus for guiding illumination light from a light source to an illuminated area. The light guiding apparatus comprises a plurality of light guiding rods, each including a first entrance end face, a first exit end face of an area smaller than that of the first entrance end face, and a first reflection surface for guiding the illumination light incident on the first entrance end face to the first exit end face while reflecting the illumination light at an inner surface thereof; and a tapered rod including a second entrance end face, a second exit end face of an area larger than that of the second entrance end face, and a second reflection surface for guiding the illumination light to the second exit end face while reflecting the illumination light incident on the second entrance end face at an inner surface thereof, wherein each of the first exit end faces of the light guiding rods is in contact with the second entrance end face and a total of the areas of the first exit end face is almost equal to an area of the second entrance end face.

Preferably, a maximum expansion angle β1max of the illumination light emitting from the first exit end face satisfies the following equation:
β1max≦τ1+(π/2−θ1),
where τ1 is an angle between a first central axis orthogonal to the first entrance end face of the light guiding rod and the first second reflection surface, and θ1 is a critical angle at the first reflection surface.

Preferably, a maximum expansion angle β2max of the illumination light incident from the second exit end face satisfies the following equation:
β2max≦τ2+(π/2−θ2),
where τ2 is an angle between a second central axis orthogonal to the second exit end face of the tapered rod and the second reflection surface, and θ2 is a critical angle at the second reflection surface.

Advantageously, a maximum expansion angle γmax of the illumination light emitting from the second exit end face satisfies the following equation:
γmax≦π/2−θ2−τ2,
where τ2 is an angle between a second central axis orthogonal to the second exit end face of the tapered rod and the second reflection surface, and θ2 is a critical angle at the second reflection surface.

The invention is also related to a solid light guiding apparatus for guiding illumination light from a light source to an illuminated area along an optical axis. The light guiding apparatus comprises a first entrance end face orthogonal to the optical axis and receiving the illumination light; a mirror surface for guiding the illumination light incident on the first entrance end face while reflecting the illumination light at an inner surface thereof and for approaching the optical axis as the illumination light moves on to a exit side; and an exit face for radiating the illumination light reflected at least at the mirror surface, wherein an angle between the illumination light emitting from the exit face and the optical axis after emission is smaller than angle before emission.

Advantageously, the exit face is a wall surface of a wedge-shaped space provided on the exit side.

Advantageously, illumination light satisfying a requirement for total reflection at the exit face of the illumination light that has reached the exit face is converted into another type of illumination light that enters the exit face at an angle not satisfying the requirement for total reflection while repeating reflection between the exit face and the mirror surface to be radiated from the exit face.

The invention is also directed to an illumination apparatus using the light guiding apparatus mentioned above. The illumination apparatus comprises the light source that is plural and is disposed so that the emitted illumination light enters each of the first entrance end faces.

Preferably, the plurality of light sources includes a plurality of light source elements that emits illumination light of red, green and blue, respectively, and the plurality of light source elements are disposed opposite to the first entrance end faces so that the illumination light incident on the first entrance end faces contains red, green and blue.

The invention is furthermore directed to an image projection system using the illumination apparatus mentioned above. The image projection system comprises a space modulation unit illuminated by the illumination light emitted from the second exit end face or exit face; and a projection optical unit for projecting the illumination light modulated by the space modulation unit.

### BRIEF DESCRIPTION OF THE DRAWINGS

FIG. 1 is an illustrative view for structure of an image projection system of a first embodiment in accordance with the invention.

FIG. 2A is a front view of a light guiding apparatus and an illumination apparatus of the first embodiment in accordance with the invention.

FIG. 2B is a view seen from an arrow X in FIG. 2A.

FIG. 2C is a cross-sectional view taken from a line Y-Y in FIG. 2A.

FIG. 2D is a cross-sectional view taken from a line Z-Z in FIG. 2A.

FIG. 3 is a plan view illustrating an angle range for incident light and outgoing light in the light guiding apparatus of the first embodiment in accordance with the invention.

FIG. 4 is a cross-sectional view of an illumination device of the illumination apparatus of the first embodiment in accordance with the invention.

FIG. 5 is a first lighting sequence at the time when the illumination apparatus of the image projection system shown in FIG. 1 emits illumination light.

FIG. 6 is a flowchart for setting a shape of the light guiding apparatus of the image projection system shown in FIG. 1.

FIG. 7 is a characteristic distribution graph for illustrating light beam incoming and outgoing angle distribution when illumination light enters the light guiding apparatus shown in FIG. 1, where a horizontal axis represents a refraction angle for a light-guiding rod and a vertical axis shows an outgoing angle for the light-guiding rod.

FIG. 8 is a characteristic distribution graph for illustrating light beam incoming and outgoing angle distribution when illumination light enters the light guiding apparatus shown in FIG. 1, where a horizontal axis represents an outgoing angle for a tapered rod and a vertical axis shows an incoming angle for the tapered rod.

FIG. 9A is a plan view of a first variant of the light guiding apparatus of the first embodiment in accordance with the invention.

FIG. 9B is a view seen from an arrow X shown in FIG. 9A.

FIG. 10A is a plan view of a second variant of the light guiding apparatus of the first embodiment in accordance with the invention.

FIG. 10B is a view seen from an arrow X shown in FIG. 10A.

FIG. 11 is a plan view of a variant of the illumination device of the first embodiment in accordance with the invention.

FIG. 12A is a plan view of a variant of the illumination apparatus of the first embodiment in accordance with the invention.

FIG. 12B is a view seen from an arrow X in FIG. 12A.

FIG. 12C is a view seen from an arrow Y in FIG. 12A.

FIG. 13 is a front view of a light guiding apparatus of a second embodiment in accordance with the invention.

FIG. 14 is a front view of a variant of a compound tapered rod of the light guiding apparatus of the second embodiment in accordance with the invention.

FIG. 15A is a plan view of a variant of an illumination apparatus of the second embodiment in accordance with the invention.

FIG. 15B is a cross-sectional view taken along a line X-X in FIG. 15A.

FIG. 15C is a view seen from an arrow Y in FIG. 15A.

FIG. 16A is a plan view of a variant of a light guiding apparatus of the second embodiment in accordance with the invention.

FIG. 16B is a cross-sectional view taken along a line X-X in FIG. 16A.

FIG. 16C is a view seen from an arrow Y in FIG. 16A.

FIG. 17A is a plan view of an illumination apparatus of a third embodiment in accordance with the invention.

FIG. 17B is a cross-sectional view taken along a line X-X in FIG. 17A.

FIG. 17C is a view seen from an arrow Y in FIG. 17A.

FIG. 18A is a plan view of a variant of a light guiding apparatus of a third embodiment in accordance with the invention.

FIG. 18B is a cross-sectional view taken along a line X-X in FIG. 18A.

FIG. 18C is a view seen from an arrow Y in FIG. 18A.

FIG. 19 is a second lighting sequence at the time when the illumination apparatus in the image projection system of each embodiment in accordance with the invention emits illumination light.

FIG. 20 is a third lighting sequence at the time when the illumination apparatus in the image projection system of each embodiment in accordance with the invention emits illumination light.

FIG. 21 is a fourth lighting sequence at the time when the illumination apparatus in the image projection system of each embodiment in accordance with the invention emits illumination light.

FIG. 22 is a fifth lighting sequence at the time when the illumination apparatus in the image projection system of each embodiment in accordance with the invention emits illumination light.

FIG. 23A is a plan view of an illumination device provided with a cooling unit of each embodiment in accordance with the invention.

FIG. 23B is a view seen from an arrow X in FIG. 23A.

FIG. 23C is a cross-sectional view taken along a line Y-Y in FIG. 23B.

### DETAILED DESCRIPTION OF THE INVENTION

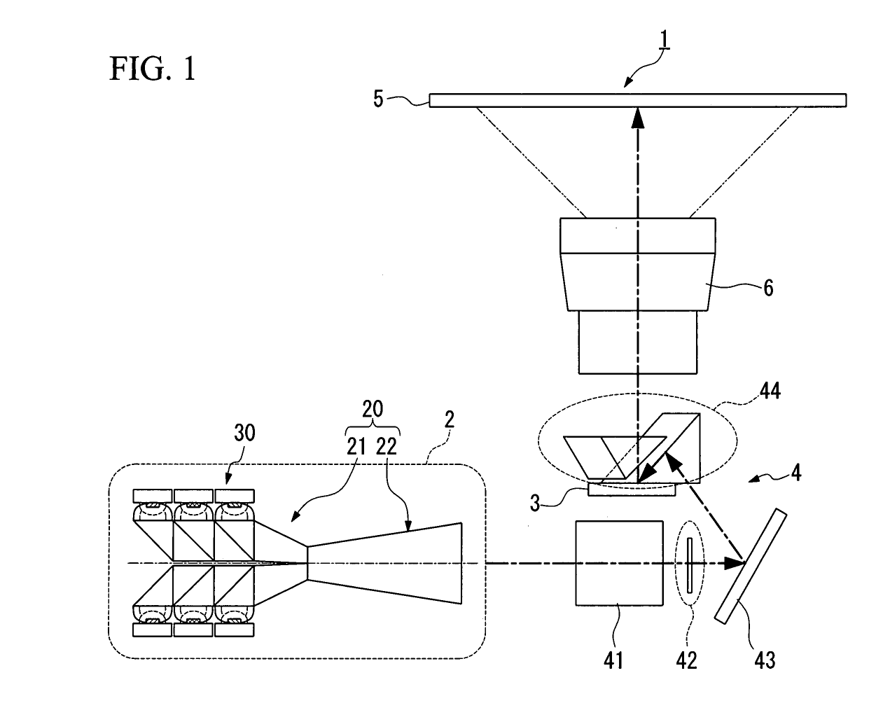

A first embodiment in accordance with the invention will be described referring to FIGS. 1-12.

FIG. 1 shows a structure of an image projection system of a first embodiment in accordance with the invention. An image projection system 1 of the embodiment, as shown in FIG. 1, projects an image according to image information input so that an observer can observe the image. The image projection system 1 includes an illumination apparatus 2 having a light guiding apparatus 20, a DMD (digital micro-mirror device) (space modulation unit) 3 that is modulated in response to image information to be input, an illumination optical unit 4 for guiding illumination light emitted from the illumination apparatus 2 to illuminate the DMD 3, and a projection lens 6 for projecting an image modulated by the DMD 3 on a screen 5.

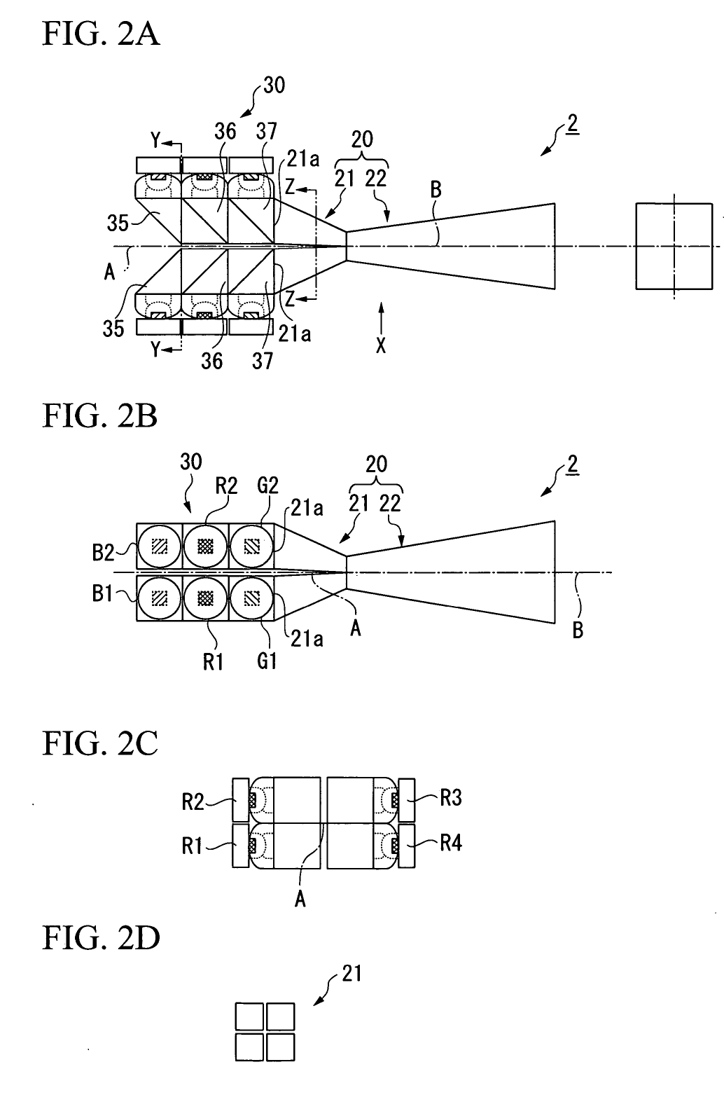

FIGS. 2A-2D show the light guiding apparatus 20 and the illumination apparatus 2 of the first embodiment. The illumination apparatus 2 includes a plurality of illumination devices (light source unit) 30 for emitting illumination light and being placed so that the illumination light can enter each first entrance end face 21a of the light guiding apparatus 20, and the light guiding apparatus 20 for guiding the illumination light emitted by the illumination devices 30 to the illumination optical unit 4. FIG. 2A is a front view of the light guiding apparatus 20 and the illumination apparatus 2. FIG. 2B is a view seen from an arrow X in FIG. 2A. FIG. 2C is a cross-sectional view taken from a line Y-Y in FIG. 2A. FIG. 2D is a cross-sectional view taken from a line Z-Z in FIG. 2A.

The light guiding apparatus 20 contains a plurality of light-guiding rods 21 for converting the illumination light emitted from the illumination devices 30 to light having a larger NA, and a tapered rod 22 for guiding the illumination light from the light-guiding rods 21 to the illumination optical unit 4. The light-guiding rods 21 and tapered rod 22 are solid rods with intermediate density consisting of crystal.

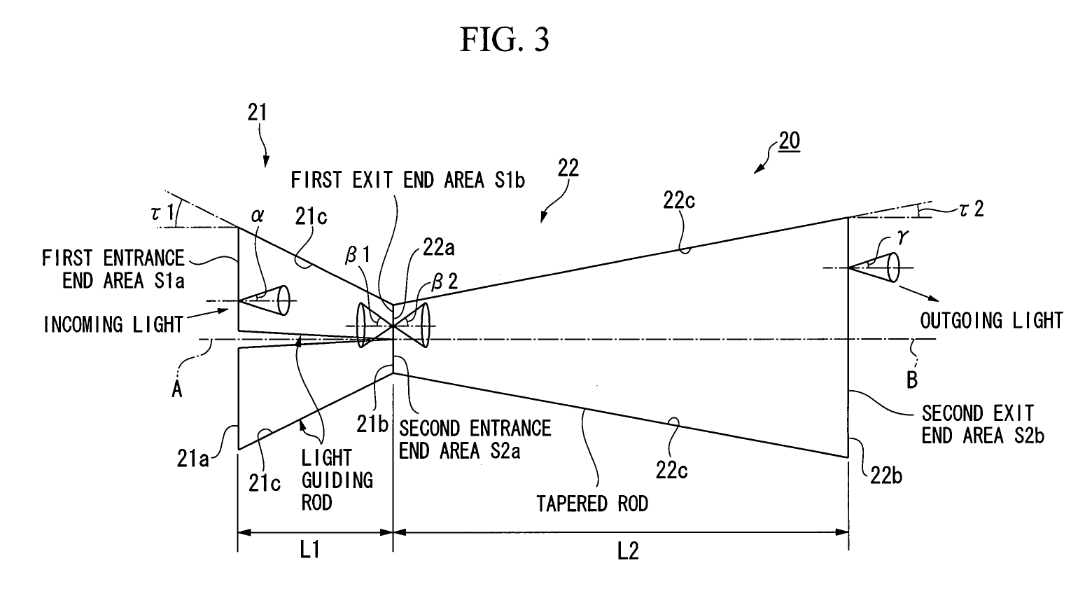

FIG. 3 illustrates an angle range for incident light and outgoing light in the light guiding apparatus 20 of the first embodiment. The light-guiding rods 21 contains a first entrance end face 21a, a first exit end face 21b having a smaller area S1b than an area S1a of the first entrance end face 21a, and a first reflection surface 21c for guiding the illumination light, being reflected at an inner surface thereof, from the first entrance end face 21a to the first exit end face 21b. The first reflection surface 21c shows an entire surrounding surface of the light-guiding rods 21.

The tapered rod 22 includes a second entrance end face 22a, a second exit end face 22b having a larger area than an area of the second entrance end face 22a, and a second reflection surface 22c for guiding the illumination light, being reflected at an inner surface thereof, from the second entrance end face 22a to the second exit end face 22b. The second exit end face 22b shows an entire surrounding surface of the tapered rod 22.

The light-guiding rods 21 consists of a plurality of rods (for example, as shown in FIG. 2D, the number is four around a first central axis A, which will be described later), while the tapered rod 22 is comprised of one. Each of the first exit end faces 21b of the plurality of light-guiding rods 21 contacts with the second entrance end face 22a, and the total of the area S1b of the plurality of first exit end face 21b is approximately equal to an area S2a of the second entrance end face 22a.

The shapes of the light-guiding rods 21 and the tapered rod 22 satisfy the following requirements.

With respect to the light-guiding rods 21, as shown in FIG. 3, where an inclination angle (an angle between the first central axis A orthogonal to the first entrance end face 21a and the first reflection surface 21c) of the first reflection surface 21c is set as τ1, and a critical angle at the first reflection surface 21c is set as θ1, the shape of the light-guiding rods 21 is designed so that a maximum expansion angle β1max of the illumination light emitted from the first exit end faces 21b of the light-guiding rods 21 satisfies the following equation:
β1max≦τ1+(π/2−θ1) (Equation 1)

Regarding the tapered rod 22, where an inclination angle (an angle between the second central axis B orthogonal to the second exit end face 22b and the second reflection surface 22c) of the second reflection surface 22c is set as τ2, and a critical angle at the second reflection surface 22c is set as θ2, the shape of the tapered rod 22 is designed so that a maximum expansion angle β2max of the illumination light emitted from the second entrance end faces 22a satisfies the following equation:
β2max≦τ2+(π/2−θ2) (Equation 2)

Furthermore, with regard to the tapered rod 22, where an angle between the second central axis B orthogonal to the second exit end face 22b and the second reflection surface 22c is designated as τ2, and a critical angle at the second reflection surface 22c is designated as θ2, the shape of the tapered rod 22 is designed so that a maximum expansion angle (a refraction angle of the outgoing light at the second exit end face 22b) γmax of the illumination light emitted from the second exit end faces 22b satisfies the following equation:
γmax≦π/2−θ2−τ2 (Equation 3)

The first central axis A is almost identical to the second central axis B.

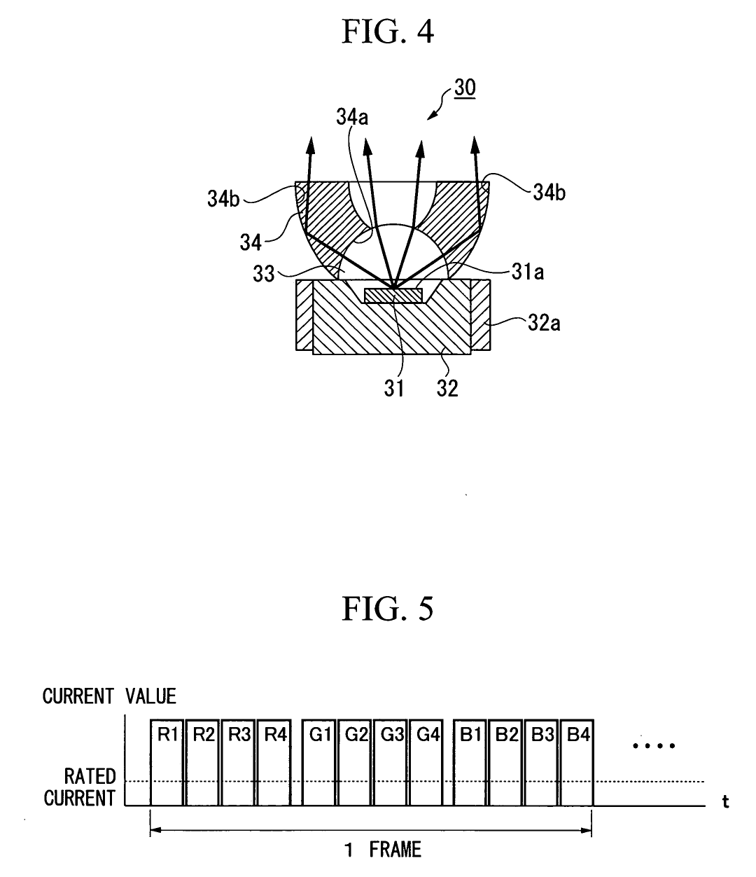

FIG. 4 shows a cross-section of an illumination device 30 of the illumination apparatus of the first embodiment. The illumination device 30 includes a light emitting device (LED) 31 having a light emitting portion 31a for emitting illumination light that is to be spread, a base portion 32 on which the LED 31 is mounted, a hemispherical lens portion 33 centered at the light emitting portion 31a for covering the light emitting portion 31a (the hemispherical lens portion 33 fits into a dented portion 34, which is explained later), and a condenser 34 for emitting spread light from the LED 31 outside. The condenser 34 has a reflection surface 34b for condensing light, where incoming spread light is converted to be parallel. The LED 31 and the base 32 are integrated as one unit by a package 32a.

The lens portion 33 does not have to be hemispherical, and may be rectangular. In this case, the rectangular lens portion 33 needs to be fit into the dented portion 34a of the condenser 34.

The LED 31 is described here referring to FIGS. 2B and 2C, where a plurality of LEDs with the same color, for example, red LEDs (R1, R2, R3, and R4) are arranged facing opposite about the first central axis A orthogonal to the first entrance end face 21a. For example, in this embodiment, since two LEDs are placed across the first central axis A, respectively, a total of four LEDs 31 is placed facing the light-guiding rods 21, in the order of blue LEDs (B1, B2, B3, and B4), red LEDs (R1, R2, R3, and R4) and green LEDs (G1, G2, G3, and G4). The LEDs 31 having each color are arranged corresponding to their first entrance end face 21a, so that illumination light incident from the first entrance end face 2 la can include red, green and blue.

The above-mentioned illumination device 30, which is shown in FIG. 2A, is explained here. The illumination device 30 contains a set of prisms 35 for reflecting illumination light emitted from the blue LEDs (B1, B2, B3, and B4) to guide the illumination light to the light-guiding rods 21, a first set of dichroic prisms 36 for reflecting the illumination light emitted from the red LEDs (R1, R2, R3, and R4) to guide the illumination light to the light-guiding rods 21, and a second set of dichroic prisms 37 for reflecting the illumination light emitted from the green LEDs (G1, G2, G3, and G4) to guide the illumination light to the light-guiding rods 21, and for passing through the illumination light emitted from the blue LEDs (B1, B2, B3, and B4) and the red LEDs (R1, R2, R3, and R4). The arrangement of the prisms and the dichroic prisms for the blue LEDs, the red LEDs, and the green LEDs (G1, G2, G3, and G4) is not limited to the example of the embodiment. Any arrangement is acceptable as far as light path, through which illumination light for each color can be combined, may be formed.

The illumination optical unit 4, which is shown in FIG. 1, contains a relay lens 41, an illumination stop 42, a reflection mirror 43, and a TIR prism 44. Adjacent to the illumination apparatus 2, the relay lens 41, the illumination stop 42, and the reflection mirror 43 are provided in that order. Light reflected by the reflection mirror 43 is supposed to enter the DMD 3 by the TIR prism 44.

The TIR prism 44 is composed of two prisms with air layer therebetween, and has a function that enters into the DMD 3 by total reflection the illumination light reflected by the reflection mirror 43.

The projection lens 6, as shown in FIG. 1, is placed in front of the screen 5 with a predetermined distance therebetween. The DMD 3is a semiconductor switch that includes a plurality of infinitesimally mobile mirrors (not shown), and is positioned between the projection lens 6 and the light source apparatus 2. The infinitesimally mobile mirrors change an angle thereof in response to an ON or OFF state of electric power source. When the electric power source is ON, the infinitesimally mobile mirrors function to direct the illumination light to the projection lens 6. Responding to an image to be input, an ON or OFF state of the infinitesimally mobile mirrors is controlled in order to modulate the illumination light. In this way, controlling an ON or OFF state enables modulated images illuminated by the illumination light to be entered into the projection lens 6.

FIG. 5 represents a lighting sequence at the time when the illumination apparatus 2 emits illumination light. The lighting sequence of the illumination light given out from the illumination device 30 contains frames. One frame, as shown in FIG. 5, constitutes a series of four pulses, that is, turn-on pulses, for each of red (R1-R4), green (G1-G4), and blue (B1-B4) LEDs that appears in the order. FIG. 5 represents an applied current of red (R1-R4), green (G1-G4), and blue (B1-B4) LEDs on a vertical axis. Since light quantity (light intensity) of the LEDs is proportional to an applied current, the value of the applied current actually represents the light quantity (light intensity) of each color. In this way, since turn-on pulses can flow several times as many currents as rated currents can, illumination light with enough brightness (light quantity) can be obtained.

According to the image projection system 1 and the illumination apparatus 2 that are constructed in this way, projecting an image on the screen 5 will be described below.

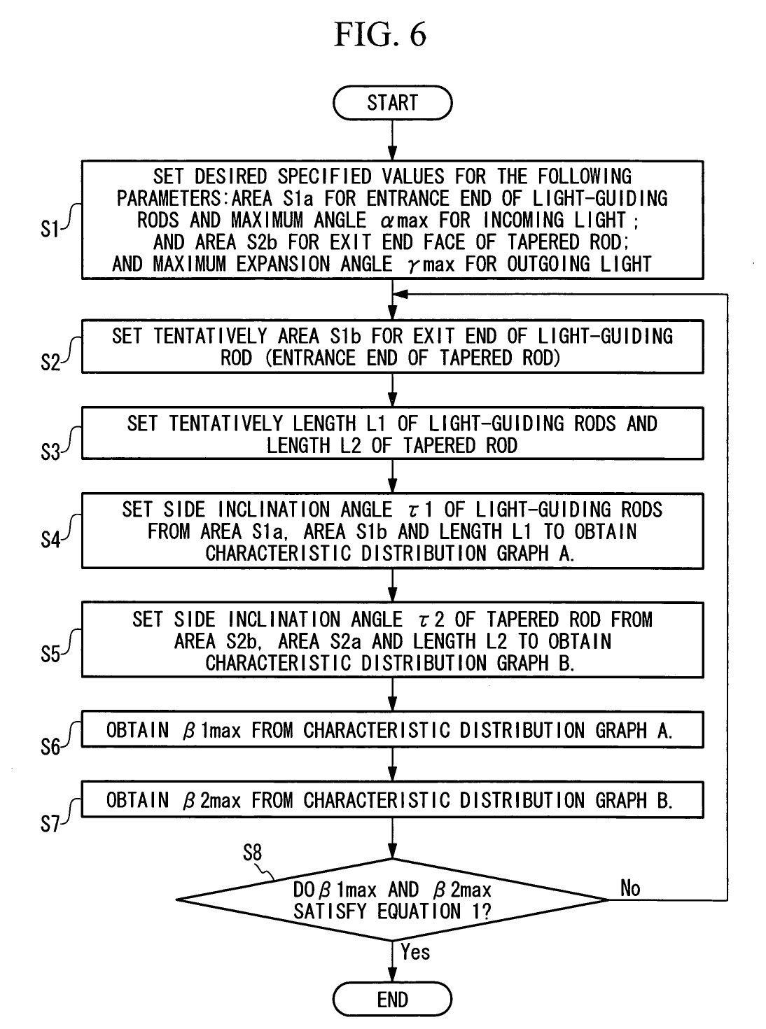

FIG. 6 is a flowchart for setting a shape of the light guiding apparatus 20. It will be explained how the shapes of the light guiding rod 21 and the tapered rod 22 are set, referring to the flowchart in FIG. 6.

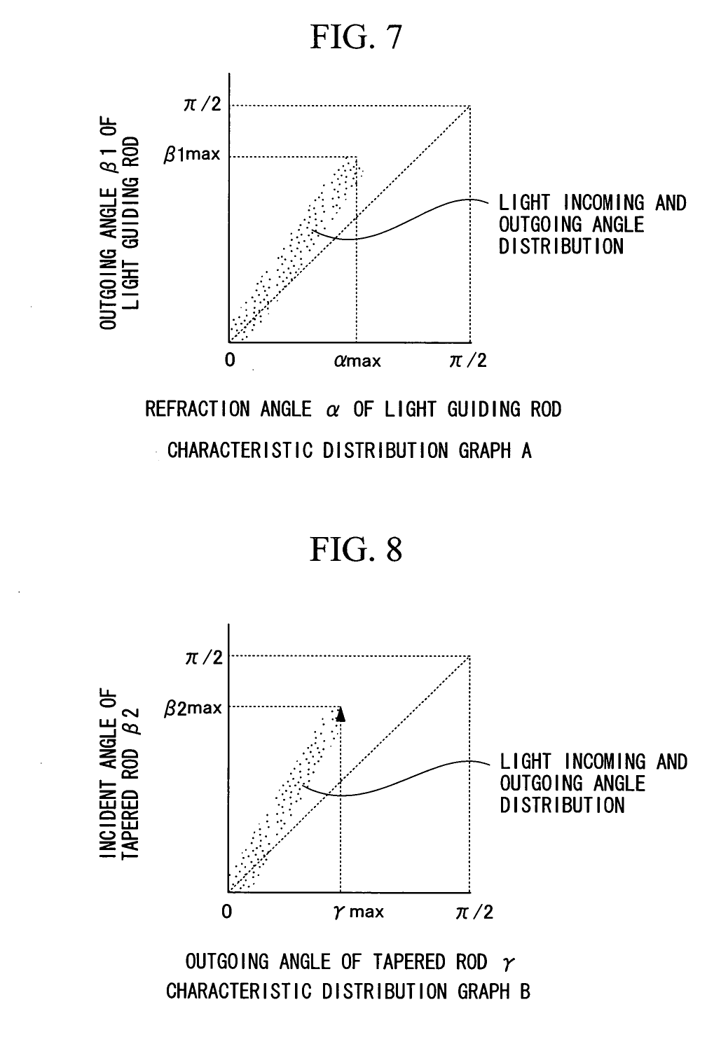

FIG. 7 is a characteristic distribution graph for illustrating light beam incoming and outgoing angle distribution when illumination light enters the light guiding apparatus 20. The horizontal axis represents a refraction angle for the light-guiding rod 21, and the vertical axis shows an outgoing angle for the light-guiding rod 21.

FIG. 8 is a characteristic distribution graph for illustrating light beam incoming and outgoing angle distribution when illumination light enters the light guiding apparatus 20. The horizontal axis represents an outgoing angle for the tapered rod 22, and the vertical axis shows an incoming (incident) angle for the tapered rod 22.

The desired specified values for the following parameters are set: the area S1a for the first entrance end face 21a of the light-guiding rods 21; a maximum refraction angle αmax for incoming light at the first entrance end face 21a ; an area S2b for the exit end face of the tapered rod 22; and a maximum expansion angle γmax for outgoing light at the second exit end face 22b that satisfies equation 3 (Step S1). The area S1b for the first exit end face 21b of the light-guiding rods 21 is tentatively set (Step S2), and as shown in FIG. 3, the length L1 of the light-guiding rods 21 and the length L2 of the tapered rod 22 are tentatively set (Step S3). Then, from the area S1a for the first entrance end face 21a; the area S1b for the first exit end face 21b and the length L1 of the light-guiding rods 21, an inclination angle τ1 of the light-guiding rods 21 is tentatively set. As shown in FIG. 7, a characteristic distribution graph A is obtained, where a horizontal axis shows a refraction angle a of incoming light to the light-guiding rods 21 and a vertical axis represents an outgoing angle β1 of the illumination light emitting from the first exit end face 21b (Step S4). From the area S2b of the second exit end face 22b, the area S2a for the second entrance end face 22a (the area S1b for the first exit end face) and the length L2 of the tapered rod 22, an inclination angle τ2 of the tapered rod 22 is tentatively set. As shown in FIG. 8, a characteristic distribution graph B is obtained, where a horizontal axis shows an outgoing angle at the second exit end face 22b of the tapered rod 22 and a vertical axis represents a refraction angle β2 at the second entrance end face 22a of the tapered rod 22 (Step S5).

Making use of the characteristic distribution graph A, an outgoing angle β1 of illumination light emitting from the first exit end face 21b is obtained (Step S6). Then, owing to the characteristic distribution graph B shown in FIG. 8, a refraction angle β2 at the second entrance end face 22a of the papered rod 22 is obtained (Step S7). When each of the outgoing angle β1 and the refraction angle β2 satisfies Equations 1 and 2, the shape of the light guiding rod 21 and the tapered rod 22 is determined, respectively (Step S8, “YES”).

On the other hand, each of the outgoing angle θ1 and the refraction angle θ2, both obtained, does not satisfy Equations 1 and 2, the step returns to Step S2, where the area S1b of the first exit end face 21b of the light guiding rod 21 is tentatively set once again (Step S8, “NO”).

The reason why tentative setting is performed is that each of the outgoing angle β1 and the refraction angle β2, both of which are obtained, does not satisfy Equations 1 and 2 (Step S8, “NO”), these tentative setting values can be differentiated from the previous ones.

After the shapes of the light-guiding rods 21 and the tapered rod 22 have been determined, respectively, light from each LED 31 enters the prism 35 and the first and second dichroic mirrors 36 and 37 based on the turn-on sequence shown in FIG. 5. The illumination light reflected at transmitted through the prism 35 and the first and second dichroic mirrors 36 and 37 goes inside the light-guiding rods 21 from a first incidence plane, and goes to the first exit end face 21b repeating reflection at the first reflection surface 21c. The illumination light heading for the first exit end face 21b proceeds inside the tapered rod 22 from the second entrance end face 22a to go to the second exit end face 22b with repeated reflection at the second reflection surface 22c.

The illumination light emitted from the second exit end face 22b is narrowed to a predetermined width by the illumination stop 42, after relayed by the relay lens 41 as shown in FIG. 1, to be reflected by the reflection mirror 43. The reflected illumination light enters the TIR prism 44 and then the DMD 3 after repeating total reflection. The DMD 3 is modulated according to an image input to change its angle by taking ON/OFF control of an infinitesimally movable mirror in response to each color, so that the illumination light is appropriately supplied to the projection lens 6. This allows most appropriate images to be input to the projection lens 6, which projects the images to the screen 5.

The image projection system 1 and the light guiding apparatus 20 of the embodiments in accordance with the invention enable almost every light, whose NA is made larger by a plurality of light guiding rods 21, to enter the tapered rod 22. Accordingly, the light having larger NA that has entered the tapered rod 22 increases the number of reflection at the second refection surface 22c to head for the second exit end face 22b, which reduces intensity unevenness of the illumination light and enables the entire length of the light guiding apparatus 20 to be shorter.

Since the illumination device 30 is composed of a plurality of LEDs that emit the illumination light of red, green and blue color, respectively, a wide range of colors can be realized, and at the same time, illumination light having excellent brightness and color rendering can be obtained. In this way, since three primary colors of red, green and blue are used, an image having enough brightness (brilliance) with respect to all the colors can be projected.

Moreover, as mentioned above, because the illumination light emitted from the illumination apparatus 2 is excellent in brightness and color rendering and high efficient, a clear image without illumination unevenness can be projected.

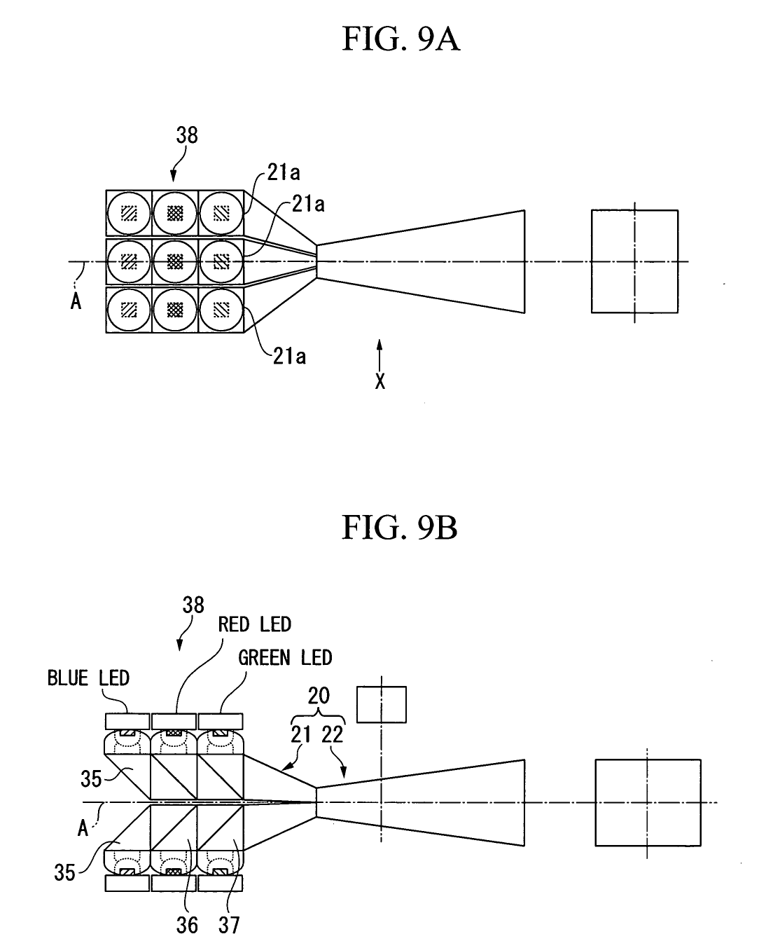

FIG. 9A is a plan view of a first variant of the light guiding apparatus 20 of the first embodiment. FIG. 9B is a view seen from an arrow X shown in FIG. 9A.

The embodiment of the invention, as shown in FIG. 2, uses a structure in which a total of four LEDs 31 are placed in the illumination device 30, with two LEDs positioned in each area across the first central axis A. However, the number of the LEDs 31 is not limited to this embodiment. For example, as shown in FIGS. 9A and 9B, three LEDs of the same color may be positioned in each area-namely, a total of six LEDs-demarcated by the first central axis A in the illumination device 38. In this structure, too, the illumination device 38 is placed opposite to the first entrance end face 21a so that red, green and blue colors can be included in the illumination light entering each of the first entrance end face 21a. Accordingly, because a total of 18 LEDs with three colors are provided with the illumination device 38, six LEDs are placed in the light guiding rod 21, which allows the number of LEDs to be increased according to their application to augment light volume.

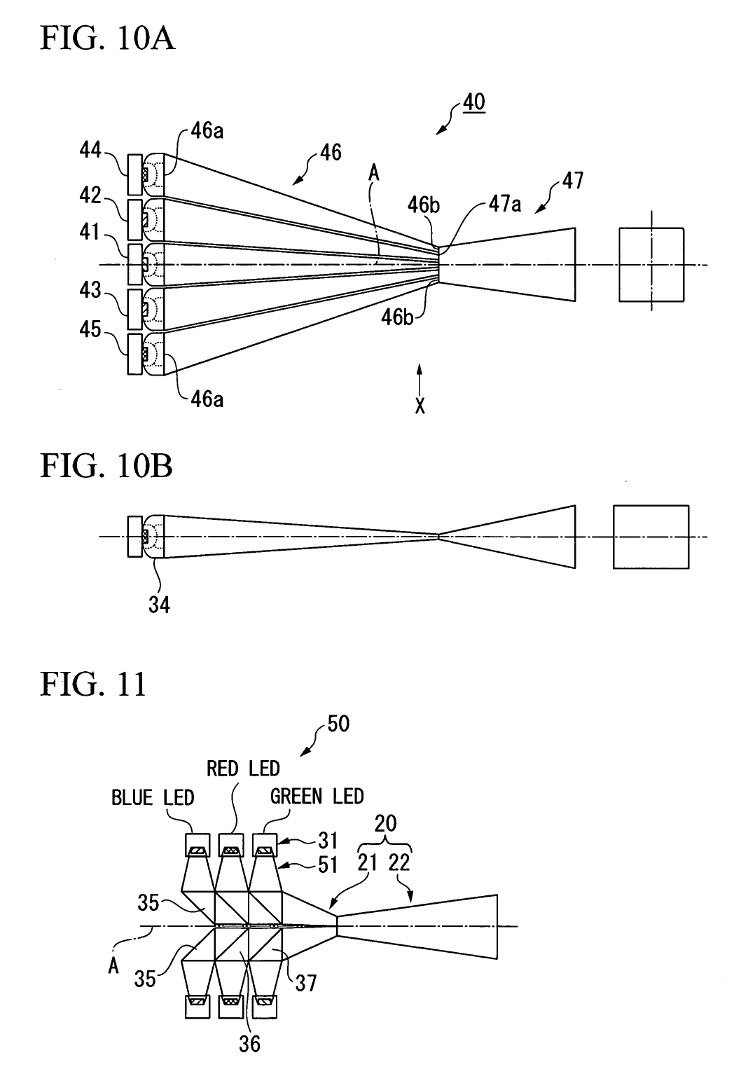

FIG. 10A is a plan view of a second variant of the light guiding apparatus 20 of the first embodiment. FIG. 10B is a view seen from an arrow X shown in FIG. 10A.

As shown in FIGS. 10A and 10B, a blue LED 41 is provided on the first central axis A. On both sides of the blue LED 41 there are provided two green LEDs 42 and 43. Furthermore, on both sides of the green LEDs 42 and 43, red LEDs 44 and 45 are provided on the same surface. For of the exit end faces of each LED, the entrance end face 46a of the light guiding rod 46 may be provided. In this case, with respect to the shape of the tapered 47, the total of the area of the exit end face 46b of each light guiding rod 46 is almost identical to the area of the second entrance end face 47a of the tapered rod 47. Using this structure enables the illumination apparatus 40 to be thinner.

FIG. 11 is a plan view of a variant of the illumination device 30 of the first embodiment.

As shown in FIG. 11, a tapered-shape light guiding rod 51 may be substituted for the condenser 34. In this case, light emitted from each LED 31 repeats total reflection at the inner surface of the light guiding rod 51 to be reflected by and transmitted through the prism 35 and the first and second dichroic mirrors 36 and 37 for heading for the light guiding rod 21. This structure allows the LEDs to be only placed in the base 32 for constituting the simple illumination device 50.

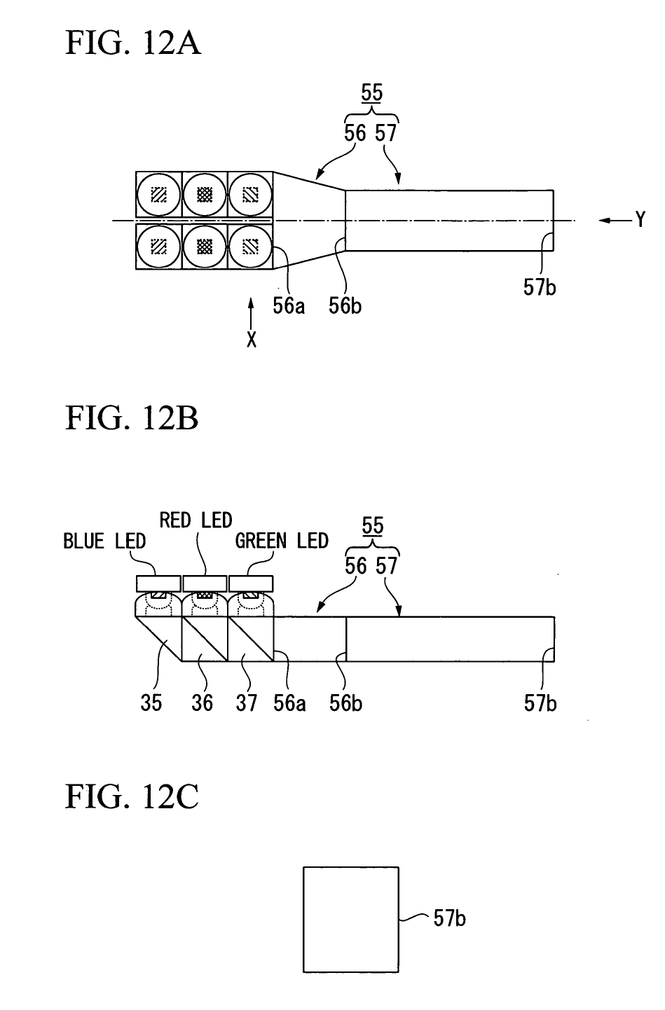

FIG. 12A is a plan view of a variant of the illumination apparatus 2 of the first embodiment. FIG. 12B is a view seen from an arrow X in FIG. 12A. FIG. 12C is a view seen from an arrow Y in FIG. 12A.

As shown in FIGS. 12A-12C, a light guiding apparatus 55 may be substituted that includes a light guiding rod 56 whose entrance end face 56a is tangent to the second dichroic mirror 37, and a parallel rod 57 that touches an exit end face 56b of the light guiding rod 56. The area of the entrance end face 56a of the light guiding apparatus 55 in contact with the second dichroic mirror 37 is almost equal to that of the total of the second dichroic mirror 37. With regard to this structure, illumination light from the entrance end face 56a of the light guiding apparatus 55 repeats total reflection inside the light guiding rod 56, and then enters the parallel rod 57 to be emitted from an exit end face 57b of the parallel rod 57. Consequently, this simple light guiding apparatus 55 can enhance use efficiency of the illumination light.

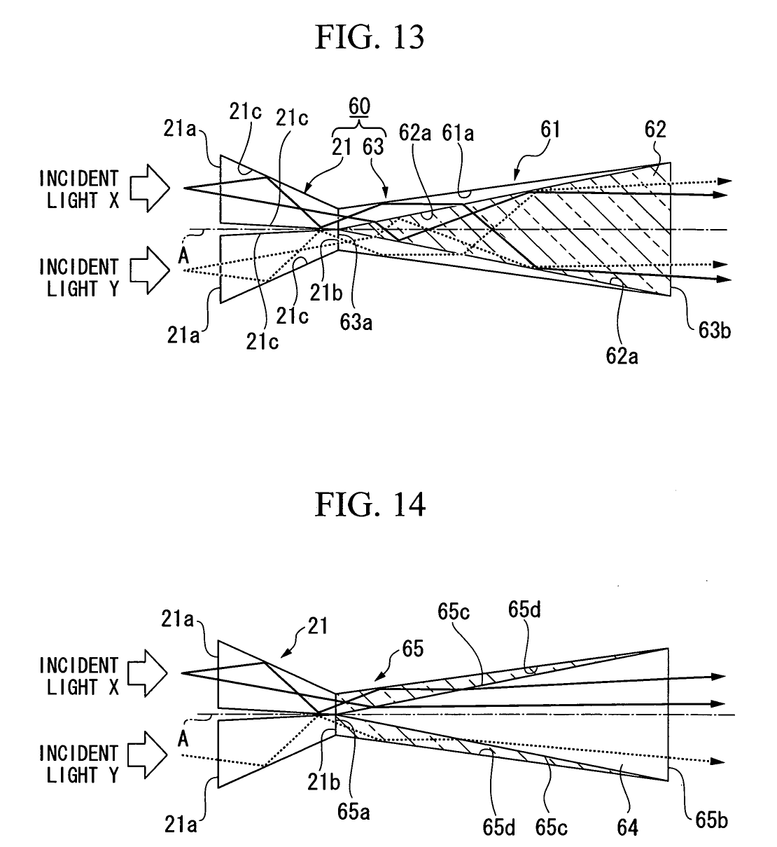

The second embodiment in accordance with the invention will be described referring to FIGS. 13-16. The same reference numeral in the image projection system 1 of the first embodiment is assigned to the same element in the image projection system of other embodiments to be described below; however no description will be made of the reference numeral.

The light guiding apparatus 60 of the second embodiment is different from that of the first embodiment in that the former includes a compound tapered rod 63 having a tapered pipe 61 in place of the tapered rod 22.

FIG. 13 is a front view of a light guiding apparatus 60 in accordance with the second embodiment.

As shown in FIG. 13, the compound tapered rod 63 has a structure in which the solid tapered rod 62 is placed in the hollow tapered pipe 61 between a second entrance end face 63a and a second exit end face 63b, and is provided to be coupled with the exit end face 21b of the light guiding rod 21.

The area of the second entrance end face 63a of the compound tapered rod 63 is almost equal to the total of the area of the first exit end face 21b. The inner surface 61a of the tapered pipe 61 is coated for mirror reflection.

Using the light guiding apparatus 60 in accordance with the embodiment having this structure, it will be described below how an image is projected on the screen 5.

Illumination light (incident light X) from the first incidence plane 21a of the light guiding rods 21 disposed in an upper part of the first central axis A is reflected at the inner surface 21c of the light guiding rods 21, and then goes into the inner side of the tapered pipe 61. The illumination light that has entered the tapered pipe 61 is reflected at the inner surface 61a of the tapered pipe 61 to proceed inside the tapered rod 62. The illumination light that has proceeded inside the tapered rod 62 repeats total reflection at the inner surface 62a of the tapered rod 62 to enter the illumination optical unit 4 through the second exit end face 63b. Similarly, illumination light (incident light Y) from the first incidence plane 21a of the light guiding rods 21 disposed in an lower part of the first central axis A enters the illumination optical unit 4 through the second exit end face 63b. As a result, as with the first embodiment, an image is projected on the screen 5 through the projecting lens 6.

The light guiding rod 21 and the compound tapered rod 60 of the embodiment effectively ensure an area ratio of the first entrance end face 21a to the second exit end face 63b, of the light guiding rod 21 to enable realization of effective NA conversion. In addition, the tapered pipe 61 enables the illumination light to effectively emit through the second exit end face 63b, even when an expansion angle of the illumination light, which is outgoing through the first exit end face 21b and is incoming through the second entrance end face 63a, is large. The reason for this is that the illumination light reflects at the inner surface 62a of the tapered rod 62 whose taper angle is larger and goes out through the exit end face 63b. On the other hand, the illumination light, which has leaked without satisfying requirements for total reflection at the tapered rod 62, reflects at the tapered pipe 61 to enter the tapered rod 62 once again. Then, by satisfying the requirement for total reflection, the leaked illumination light goes out through the second exit end face 63b. Therefore, the light that has entered the second entrance end face 63a can be effectively emitted through the second exit end face 63b.

FIG. 14 is a front view of a variant of the compound tapered rod 63 of the light guiding apparatus 60 in accordance with the second embodiment.

In the embodiment, as shown in FIG. 14, a tapered rod 65 having a hollow portion 64 may be a substitute for the compound tapered rod 63. By employing the structure of the tapered rod 65, the illumination light, which passes the light guiding rod 21 and is incident on a second entrance end face 65a, can be almost parallel to the illumination light through the second entrance end face 65a, because the illumination light repeats total reflection at inner surfaces 65c and 65d of the tapered rod 65 to enter the inner surface 65c at an angle less than a critical angle, so that it is radiated into the hollow portion 64 to be emitted through an exit end face 65b. In the case of this structure, it is preferable that the inner surfaces 65c and 65d of the tapered rod 65 be provided with anti-reflection coat such that illumination light can effectively enter the hollow portion 64.

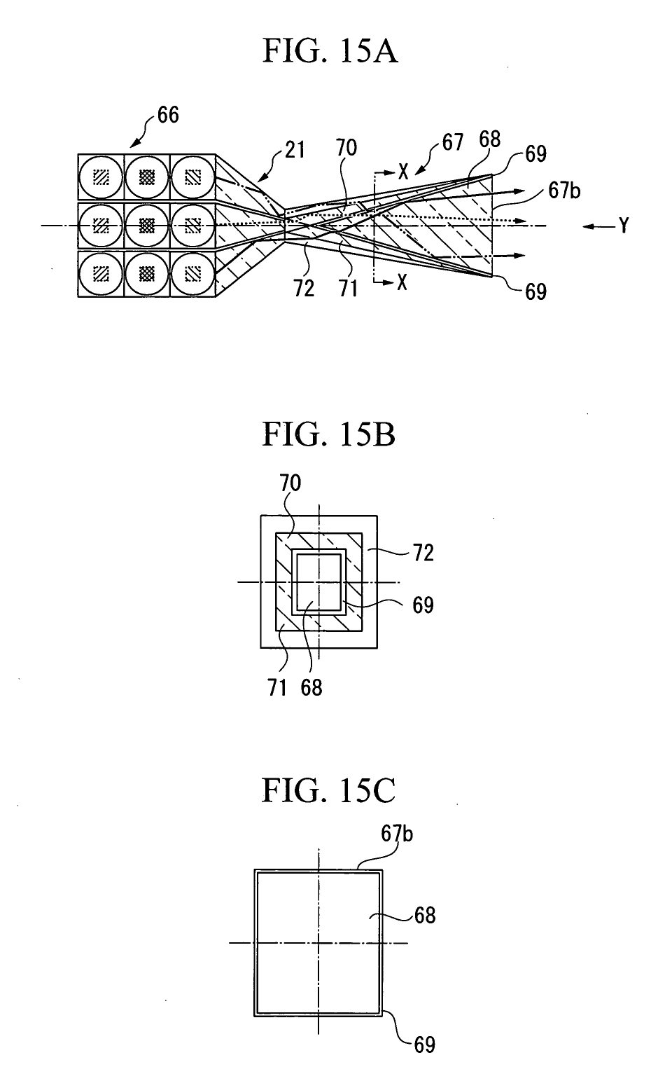

FIG. 15A is a plan view of a variant of the illumination apparatus in accordance with the second embodiment. FIG. 15B is a cross-sectional view taken along a line X-X in FIG. 15A. FIG. 15C is a view seen from an arrow Y in FIG. 15A.

Using the structure shown in FIG. 13 and the LEDs as an illumination device 66 shown in FIG. 15A, where nine LEDs are disposed on each side to oppose each other with respect to the first center axis A, the light guiding rod 21 shown in FIG. 9, and a compound tapered rod 67 in contact with the exit end face 21b of the light guiding rod 21 may be provided. In the middle of the compound tapered rod 67 is provided a main tapered rod 68, to which a first sub-rod 70 and a second sub rod 71 are mounted via an air layer 69. The inner sides of the sub-rods 70 and 71 are covered with a hollow tapered pipe 72 having a mirror reflection coating, which leads a large amount of light from the illumination device 66 to be effectively emitted from a second exit end face 67b and directed to the illumination optical unit 4.

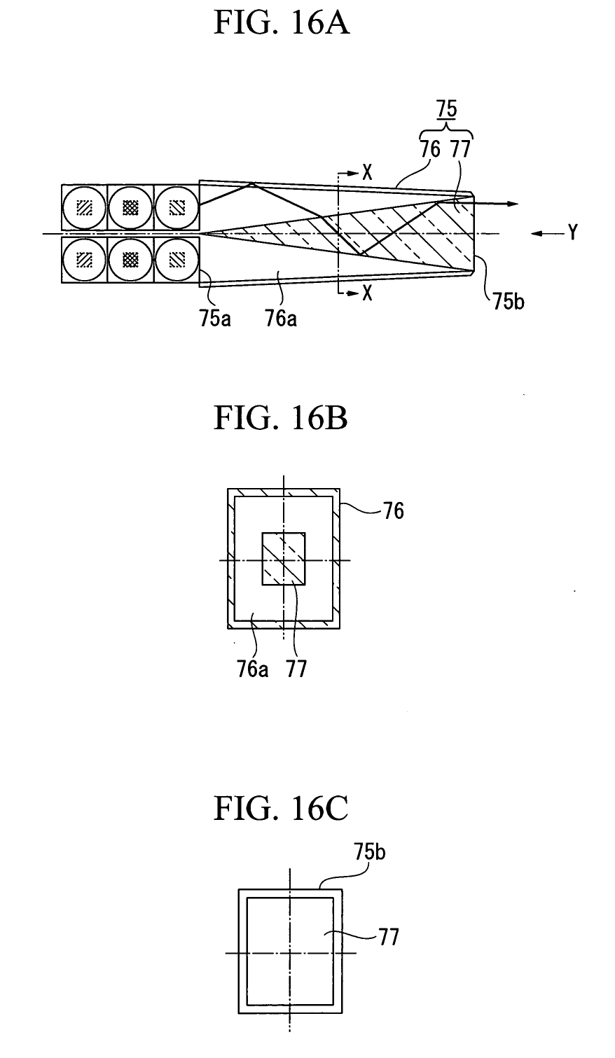

FIG. 16A is a plan view of a variant of a light guiding apparatus in accordance with the second embodiment. FIG. 16B is a cross-sectional view taken along a line X-X in FIG. 16A. FIG. 16C is a view seen from an arrow Y in FIG. 16A.

As shown in FIG. 16A, a compound tapered rod 75 may be provided that consists of a reverse tapered pipe 76 including a hollow portion 76a and a tapered rod 77 provided inside the reverse tapered pipe 76. With respect to the area of the reverse tapered pipe 76, the area of the first entrance end face 75a on the side of the illumination device 30 is larger than that of the first exit end face 75b on the side of the illumination optics unit 4. This structure allows reflection times to be increased and illumination light with reduced illumination unevenness to be obtained.

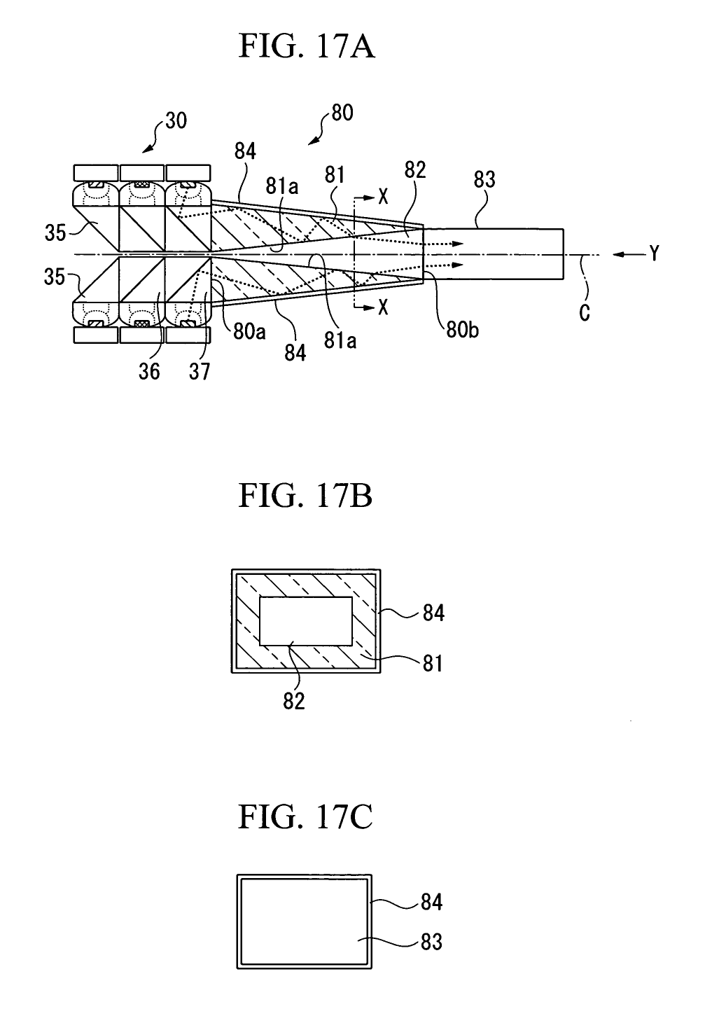

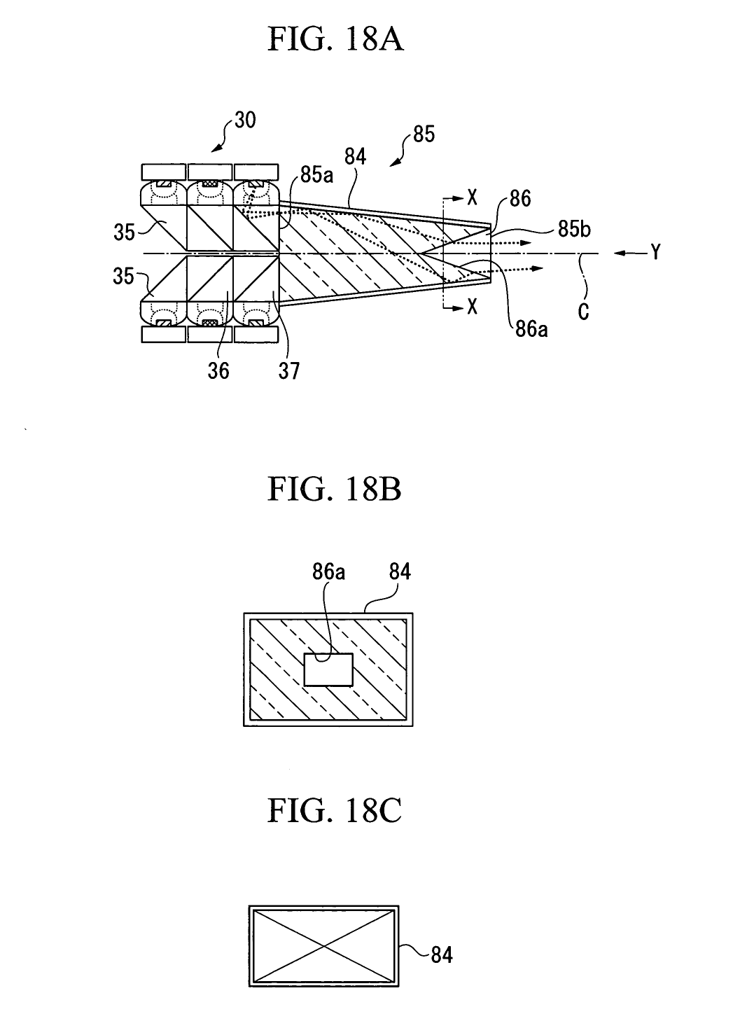

The third embodiment in accordance with the invention will be described below, referring to FIGS. 17A to 17C and 18A to 18C.

The light guiding apparatus 80 of the third embodiment differs from the light guiding apparatus of the first embodiment with respect to the shape.

FIG. 17A is a plan view of an illumination apparatus of the third embodiment in accordance with the invention. FIG. 17B is a cross-sectional view taken along a line X-X in FIG. 17A. FIG. 17C is a view seen from an arrow Y in FIG. 17A.

The light guiding apparatus 80, as shown in FIG. 17A, guides illumination light from the illumination device 30 to an illuminated area (for example, illumination optical unit 3) along an optical axis C. The light guiding apparatus 80 includes an entrance end face 80a (a first entrance end face) that is orthogonal to the optical axis and the illumination enters, a reverse tapered rod 81 for guiding and reflecting at the inner surface thereof the illumination light incident on the first entrance end face 80a and for getting closer to the optical axis C as the illumination light travels to an exit side, a mirror surface 84 positioned at the outside of the reverse tapered rod 81, and an exit end face 80b for emitting the illumination light that has entered a hollow portion 82 through an inner surface 81a of the reverse tapered rod 81 of the illumination light reflected at least at a mirror surface 84.

The light guiding apparatus 80 has a shape, in which with respect to the illumination light emitting from the inner surface 81a into the hollow 82, an angle forming with the optical axis C by refraction at the inner surface 81a after emission is smaller than that before emission. In this way, the light guiding apparatus 80 is provided with the quadrangular pyramid hollow portion 82 whose top is located on the optical axis for the first entrance end face 80a, with its bottom as the exit face 80b.

Because of this, a light beam angle for the illumination light emitting from the exit face 80b can be made smaller.

Moreover, the light guiding apparatus 80 has a shape, in which the light beam satisfying requirements for total reflection at the inner surface 81a of the illumination light that has reached the inner surface 81a is converted to be another type of light beam that hits the inner surface 81a at an angle not satisfying the requirement for total reflection, while repeating reflection between the inner surface 81a and the mirror surface 84, and is radiated into the hollow portion 82 from the inner surface 81a.

In addition, the light guiding apparatus 80 is provided with an integrator rod 83 touching the exit face 80b.

The exit face 80b is supposed to radiate illumination light from the wall surface of the hollow portion (quadrangular pyramid type space) 82 provided on the exit side of the illumination light for the light guiding apparatus 80, that is, from a side 82a of the hollow portion 82. In this embodiment, the shape of the hollow portion is a quadrangular pyramid space, which may be another type of space such as a wedge shape, pyramid, and cone.

The illumination light emitted in the hollow portion 82 is incident on the illumination optical unit 4 through the integrator rod 83. As in the first embodiment, images are t thrown onto the screen 5 through the projection lens 6.

According to the light guiding apparatus 80 in accordance with the present embodiment, a mirror surface 84 enables the number of reflection inside by the illumination light incident through the first entrance end face 80a to be increased. In addition, since the illumination light incident through the first entrance end face 80a does not transmit outside of the light guiding apparatus 80, sufficient brightness (brilliance) can be guaranteed. Furthermore, the light guiding apparatus 80 has a shape in which the illumination light is transformed into the light beam reaching the inner surface 81a at an angle not satisfying the requirement for total reflection to be radiated through the exit face 80b, which prevents the illumination light from returning once again to the inside of the light guiding apparatus 80 from the exit face 80b.

FIG. 18A is a plan view of a variant of a light guiding apparatus of the third embodiment in accordance with the invention. FIG. 18B is a cross-sectional view taken along a line X-X in FIG. 18A. FIG. 18C is a view seen from an arrow Y in FIG. 18A.

In the present embodiment, as shown in FIG. 18, a light guiding apparatus 85 ma y be the one in which a top, which is opposite to an exit face 85b of the hollow portion 82 of the light guiding apparatus 85, is positioned on the optical axis C between a first entrance end face 85a and the exit face 85b. In the case of this configuration, light entering the first entrance end face 85a of the light guiding apparatus 85 is improved by refraction at a side face 86a of a hollow portion 86 since NA is small, which as a result enhances the NA conversion effect. Consequently, because a spread angle of illumination light at emitting is smaller than that at entering, it is possible to obtain illumination light having high directivity.

The scope of the invention is not limited to the above embodiments, and various modifications can be made without departing from the gist of the invention.

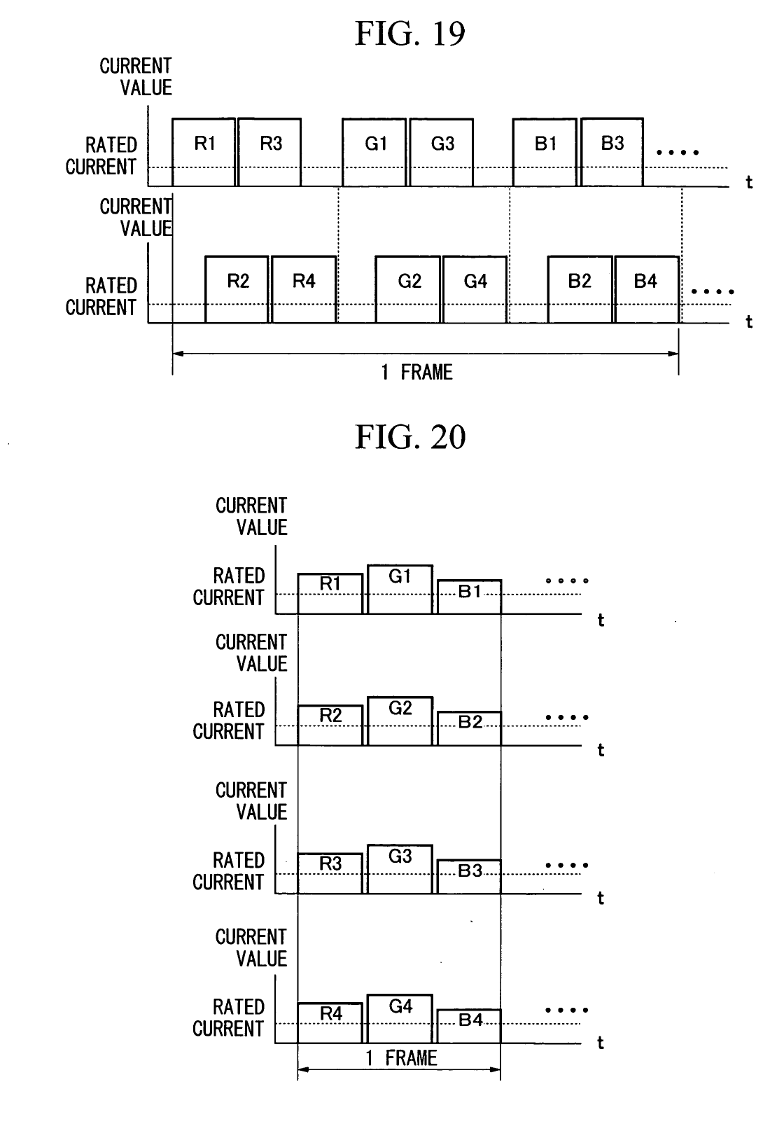

FIG. 19 is a second lighting sequence at the time when the illumination apparatus in the image projection system emits illumination light.

For example, in the lighting sequence of the illumination device 30, as shown in FIG. 19, a red LED (R2) overlaps with a red LED (R1) to be turned on; a red LED (R3) overlaps with the red LED (R2) to be turned on; and a red LED (R4) overlaps with the red LED (R3) to be turned on. Likewise, green and blue LEDs may be turned on on that order.

FIG. 20 is a third lighting sequence at the time when the illumination apparatus in the image projection system of each embodiment in accordance with the invention emits illumination light.

When a color image is displayed, green light quantity is needed most and red color is needed most next to the green. Accordingly, as shown in FIG. 20, depending on necessary light quantity, a current value may be changed to perform pulse turn-on.

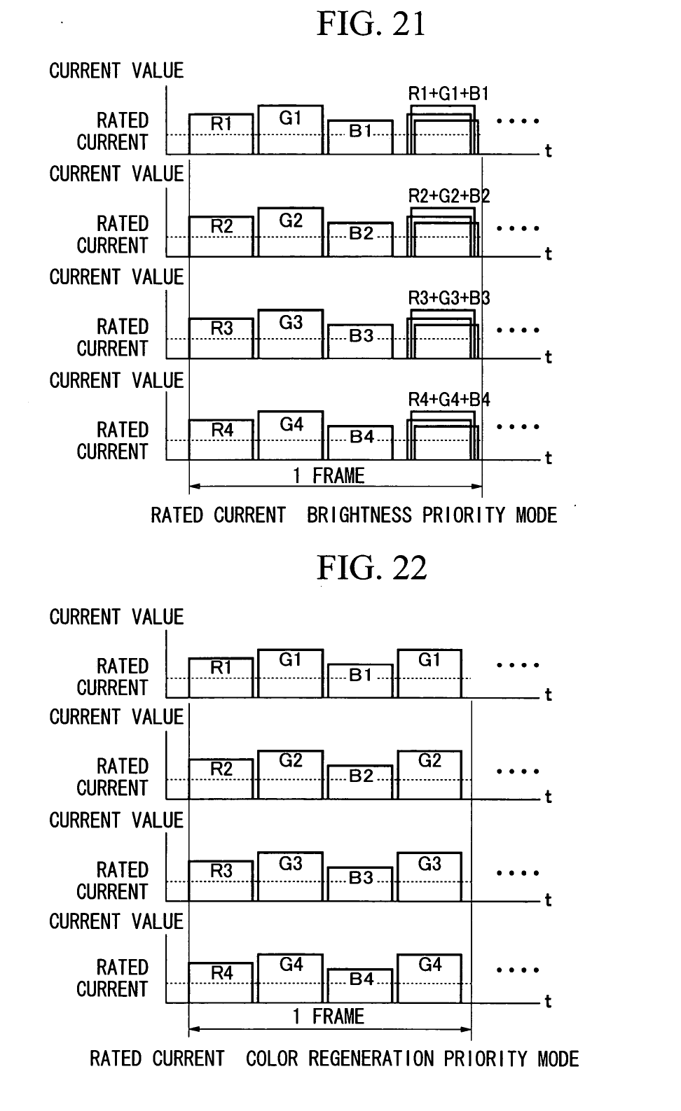

FIG. 21 is a fourth lighting sequence when the illumination apparatus emits illumination light.

FIG. 22 is a fifth lighting sequence when the illumination apparatus emits illumination light.

As shown in FIGS. 21 and 22, brightness priority mode or color reproduction priority mode can be selective. When selecting brightness priority mode, as shown in FIG. 21, there is a timing at which three colors of red, green and blue are simultaneously turned on. On the other hand, when selecting color reproduction priority mode, as shown in FIG. 22, the LEDs are turned on in order of red, green, blue and green. Because of this, since the turn-on sequence varies in response to a mode selected, an optimum projection of image information is executed depending on a situation.

The illumination device 30 has a configuration in which the LEDs are disposed opposite the light guiding rod 21 in order of blue LEDs, red LEDs and green LEDs. However, the configuration is not limited to this. In the image display system, because light quantity is necessary in order of green LEDs, red LEDs and blue LEDs, the arrangements in the embodiments are preferable since they have little loss in light quantity.

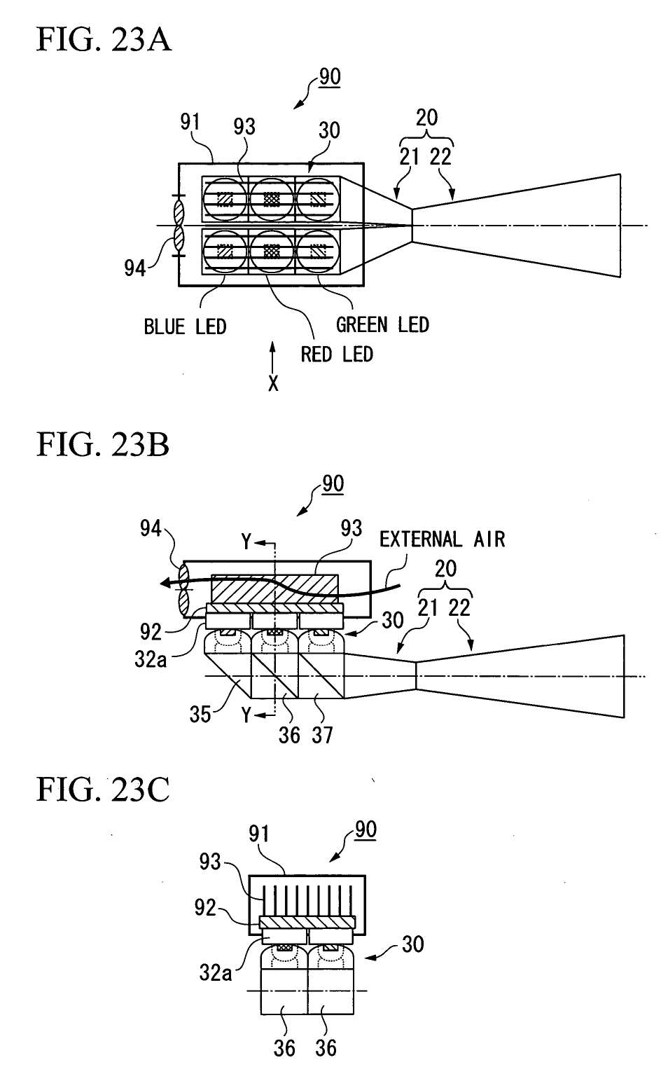

FIG. 23A is a plan view of an illumination device provided with a cooling unit. FIG. 23B is a view seen from an arrow X in FIG. 23A. FIG. 23C is a cross-sectional view taken along a line Y-Y in FIG. 23B.

As shown in FIG. 23, a cooling device 90 may be provided in order to radiate heat produced by the LEDs in the illumination device 30. The cooling device 90 contains, in a hood 91, a heat conductor 92 touching the package 32a of the illumination device 30, a radiation fin 93 for radiating heat absorbed from the heat conductor 92, an exhaust fin 94 for exhausting air inside to the outside. Therefore, working the exhaust fin 94 expels the heat produced by the LEDs outside, which reduces an influence by the heat. This enables a long-time observation of projection images and an improvement in reliability of products.

The requirement for terminating the flowchart is when β1max and β2max are satisfied. However, the flowchart may be ended when either one of β1max and β2 is satisfied depending on an application of the light guiding apparatus.

The invention has the following advantages:

The light guiding apparatus in accordance with the invention can increase number of reflection of the illumination light, whose NA is made larger by the light guiding rod, in the tapered rod that. Consequently, using the illumination apparatus incorporating the light guiding apparatus enables easy access to illumination light having a small light beam angle and little illumination unevenness. Furthermore, the smaller size of the illumination apparatus can be realized.

Moreover, since the image projection system in accordance with the invention can make use of highly efficient illumination light excellent in the aforementioned brightness (sufficient brilliance) and color rendering, clear images can be projected.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A light guiding apparatus for guiding illumination light from a light source to an illuminated area, comprising:
a plurality of light guiding rods, each including a first entrance end face, a first exit end face of an area smaller than that of the first entrance end face, and a first reflection surface for guiding the illumination light incident on the first entrance end face to the first exit end face while reflecting the illumination light at an inner surface thereof; and
a tapered rod including a second entrance end face, a second exit end face of an area larger than that of the second entrance end face, and a second reflection surface for guiding the illumination light to the second exit end face while reflecting the illumination light incident on the second entrance end face at an inner surface thereof,
wherein each of the first exit end faces of the light guiding rods is in contact with the second entrance end face and a total of the areas of the first exit end face is almost equal to an area of the second entrance end face.

2. The light guiding apparatus as recited in claim 1, wherein a maximum expansion angle β1max of the illumination light emitting from the first exit end face satisfies the following equation:
β1max≦τ1+(π/2−θ1),
where τ1 is an angle between a first central axis orthogonal to the first entrance end face of the light guiding rod and the first second reflection surface, and θ1 is a critical angle at the first reflection surface.

3. The light guiding apparatus as recited in claim 1, wherein a maximum expansion angle β2max of the illumination light incident from the second exit end face satisfies the following equation:
β2max≦τ2+(π/2−θ2),
where τ2 is an angle between a second central axis orthogonal to the second exit end face of the tapered rod and the second reflection surface, and θ2 is a critical angle at the second reflection surface.

4. The light guiding apparatus as recited in claim 1, wherein a maximum expansion angle γmax of the illumination light emitting from the second exit end face satisfies the following equation:
γmax≦π/2−θ−τ2,
where τ2 is an angle between a second central axis orthogonal to the second exit end face of the tapered rod and the second reflection surface, and θ2 is a critical angle at the second reflection surface.

5. A solid light guiding apparatus for guiding illumination light from a light source to an illuminated area along an optical axis, comprising:
a first entrance end face orthogonal to the optical axis and receiving the illumination light;
a mirror surface for guiding the illumination light incident on the first entrance end face while reflecting the illumination light at an inner surface thereof and for approaching the optical axis as the illumination light moves on to an exit side; and
an exit face for radiating the illumination light reflected at least at the mirror surface,
wherein an angle between the illumination light emitting from the exit face and the optical axis after emission is smaller than an angle before emission.

6. The solid light guiding apparatus as recited in claim 5, wherein the exit face is a wall surface of a wedge-shaped space provided on the exit side.

7. The solid light guiding apparatus as recited in claim 5, wherein illumination light satisfying a requirement for total reflection at the exit face of the illumination light that has reached the exit face is converted into another type of illumination light that enters the exit face at an angle not satisfying the requirement for total reflection while repeating reflection between the exit face and the mirror surface to be radiated from the exit face.

8. An illumination apparatus using the light guiding apparatus as recited in claim 5, wherein the light source is plural and is disposed so that the emitted illumination light enters each of the first entrance end faces.

9. The illumination apparatus as recited in claim 8, wherein the plurality of light sources includes a plurality of light source elements that emits illumination light of red, green and blue, respectively, and
wherein the plurality of light source elements are disposed opposite to the first entrance end faces so that the illumination light incident on the first entrance end faces contains red, green and blue.

10. An image projection system using the illumination apparatus as recited in claim 5, comprising:
a space modulation unit illuminated by the illumination light emitted from the second exit end face or exit face; and
a projection optical unit for projecting the illumination light modulated by the space modulation unit.

11. An illumination apparatus using the light guiding apparatus as recited in claim 1, wherein the light source is plural and is disposed so that the emitted illumination light enters each of the first entrance end faces.

12. The illumination apparatus as recited in claim 11, wherein the plurality of light sources includes a plurality of light source elements that emits illumination light of red, green and blue, respectively, and
wherein the plurality of light source elements are disposed opposite to the first entrance end faces so that the illumination light incident on the first entrance end faces contains red, green and blue.

13. An image projection system using the illumination apparatus as recited in claim 1, comprising:
a space modulation unit illuminated by the illumination light emitted from the second exit end face or exit face; and
a projection optical unit for projecting the illumination light modulated by the space modulation unit.
